(19) United States
(12) Patent Application Publication
(10) Pub. No.: US 2013/0055774 A1
(43) Pub. Date: Mar. 7, 2013

(54) COMBINATION LOCK WITH RETRACING COMBINATION

(71) Applicant: Yao Kun YANG, Changhua City (TW)

(72) Inventor: Yao Kun YANG, Changhua City (TW)

(21) Appl. No.: 13/225,558

(22) Filed: Sep. 6, 2011

(51) Int. Cl. E05B 37/02

(52) U.S. Cl. 70/307

(57) ABSTRACT

A combination lock with retracing combination includes a body, a shackle, a stick, a pivot set, a core, a plurality of sleeves and a plurality of code discs. When users rotate the core with a calibration key and rotate the code discs until the code discs is positioned, the combination digits of the code discs exposed out of the body is the correct combination digits. Therefore, if the users forget the correct combination digits, the users can retrace the correct combination digits via the calibration key inserted into the core.

### BACKGROUND OF THE INVENTION

1. Field of the Invention

The present invention relates to a combination lock, and more particularly to a combination lock with retracing combination.

2. Description of Related Art

A conventional combination lock includes two cases and a ring set, the two cases are pivotally connected to each other and the ring set is connected to one of the cases. The ring set has at least one latch in the case and the latch is retracted into the ring set when the correct digits are correctly input and the lock is unlocked. In contrast, the lock is in locked status when the latch is secured and exposed from the ring set and is not retracted into the ring set. The other case has a rib located therein and the rib has a groove which is located corresponding to the latch so that the latch is engaged with the groove to connect the two cases. When the latch is operated to the unlocked status, the latch is disengaged from the groove, and the two cases are separated.

However, the conventional combination lock does not have the function for retracing the combination, so that when the users forget the digits of the combination, the users might need to break the lock inconveniently for opening it. Thus, how to retracing the combination is an important issue.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved combination lock.

To achieve the objective, a combination lock with retracing combination comprises a body, a shackle, a stick, a pivot set, a core, a plurality of sleeves and a plurality of code discs, the stick, the pivot set and the sleeves mounted in the body, the sleeves encircled by the code discs, the code discs partially exposed out of the body, a first hole opened through the sleeve and the sleeve encircling the stick via the first hole, a plurality of block portions and a plurality of groove portions formed on the stick, the block portions and the groove portions interlaced with each other, the cross-section of the groove portion smaller than the cross-section of the block portion, the periphery of the block portion formed as polygon and the shape of the first hole corresponding to the periphery of the block portion, a first end of the shackle connected to one end of the stick and a second end of the shackle inserted into the body, the pivot set having a plurality of claspers at one side and another side of the pivot set abutted against the core, the sleeve having a second groove corresponding to the clasper.

Wherein a second hole is opened through the center of the ring; at least one third groove is defined around the second hole of the ring; at least one protrusion is formed around the sleeve; the amount of the protrusion is corresponding to the amount of the third groove; the protrusion is connected to the third groove; the pivot set has a pivot unit; a first groove is defined on the inside wall of the body for receiving the pivot unit; the pivot unit has the claspers at one side and has a block pad at another side for abutting against the core; an elastomer is mounted on the bottom of the block pad; one end of the elastomer is abutted against the block pad and another end of the elastomer is abutted against the inside wall of the body; a positioning base is mounted in the body and has a plurality of block slices; the block slices are respectively adjacent to the code discs; the claspers and the block slices are interlaced with each other; a hold ring is formed at one end of the sleeve for abutting against one side of the code discs; when the combination lock is unlocked and the core is not rotated via the calibration key, the distance from the upper clasper to the corresponding upper second groove is shorter than the other distance from the lower clasper to the corresponding lower second groove; a block rib corresponding to the block pad is formed at one end of the core.

When a user rotates the core with a calibration key, the pivot set is pushed by the block rib of the core so as to pivot the pivot unit, thereafter, the claspers press on the periphery of the sleeve; under this arrangement, the user rotates the code discs until the second groove engages with the clasper firmly, at this time, the combination digits of the code discs exposed out of the body is the correct combination digits and the periphery of the first hole is matching the shape of the block portion, so that the block portion is inserted into the first hole; consequently the stick is moving relative to the code discs so that the user pulls the shackle out of the body for separating the second end from the body and unlocking; thereby if the user forget the correct combination digits, the user can retrace the correct combination digit via the calibration key inserted into the core.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a combination lock with retracing combination of the present invention;

FIGS. 2-3 are partial assembled views of the combination lock with retracing combination of the present invention;

FIG. 4 is a perspective view of the combination lock with retracing combination of the present invention; and

FIG. 5 is a partial bottom plan view of the combination lock with retracing combination for showing all distances from the claspers to the second grooves.

### DETAILED DESCRIPTION OF THE INVENTION

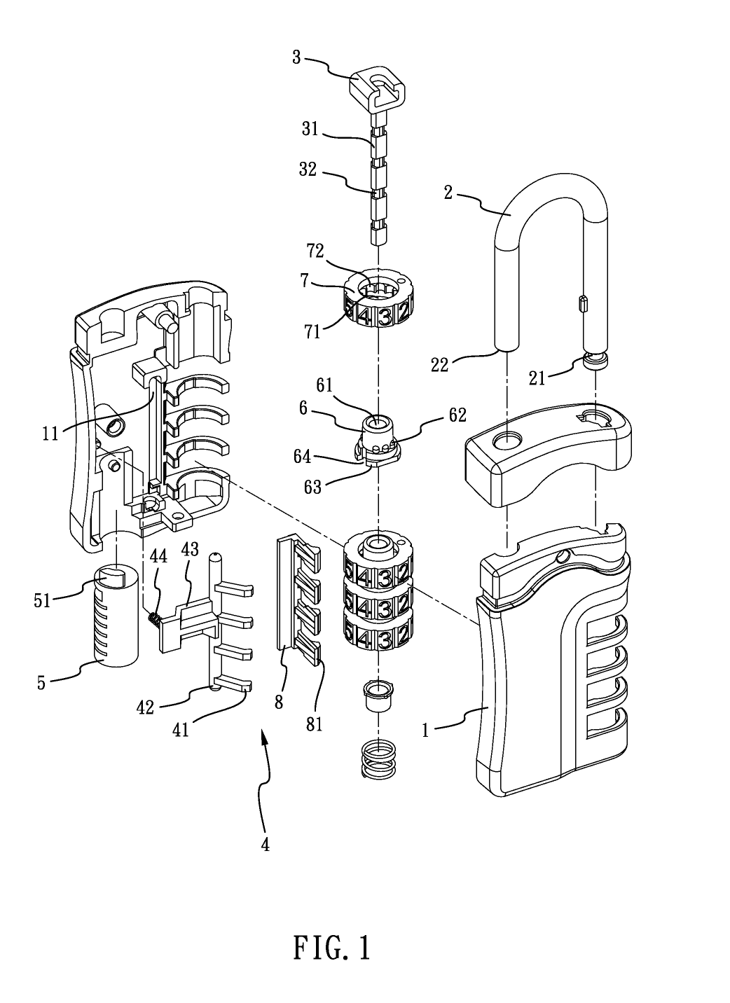

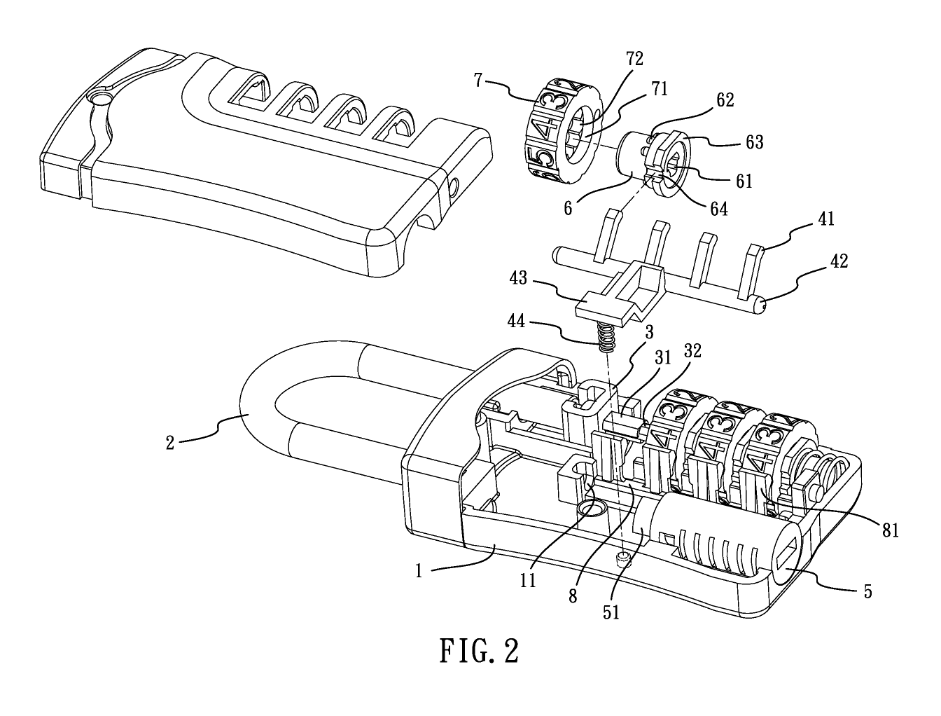

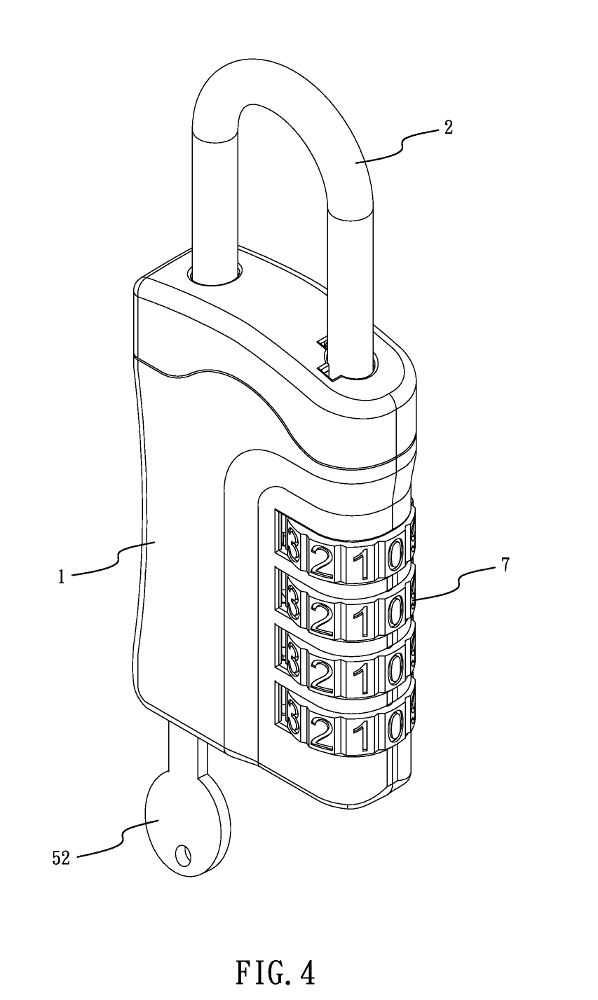

Referring to FIGS. 1-4, a combination lock with retracing combination in accordance with the present invention comprises a body (1), a shackle (2), a stick (3), a pivot set (4), a core (5), a plurality of sleeves (6) and a plurality of code discs (7). The stick (3), the pivot set (4) and the sleeves (6) are mounted in the body (1). The sleeves (6) are encircled by the code disc (7). The code discs (7) are partially exposed out of the body (1). A first hole (61) is opened through the sleeve (6). The sleeve (6) encircles the stick (3) via the first hole (61). A plurality of block portions (31) and a plurality of groove portions (32) are formed on the stick (3). The block portions (31) and the groove portions (32) are interlaced with each other. The cross-section of the groove portion (32) is smaller than the cross-section of the block portion (31). The periphery of the block portion (31) is formed as polygon. The shape of the first hole (61) is corresponding to the periphery of the block portion (31). The shackle (2) is U-shape and has two legs which are connected to the stick (3) and the body (1) respectively as shown in FIGS. 1 and 2. One leg of the shackle (2) is longer than another leg of the shackle (2). A first end (21) is defined on one leg of the shackle (2). A second end (22) is defined on another leg of the shackle (2). The stick (3) is mounted in the body (1) and adjacent to a side of the body (1). The first end (21) is connected to one end of the stick (3). The second end (22) is inserted into the body (1) or departed from the body (1) according to the moving of the shackle (2). A second hole (71) is opened through the center of the code disc (7). At least one third groove (72) is defined around the second hole (71) of the code disc (7). At least one protrusion (62) is formed around the sleeve (6). The amount of the protrusions (62) is corresponding to the amount of the third grooves (72). The protrusions (62) are engaged with the third grooves (72) so that the sleeve (6) is rotated by the rotation of the code disc (7). A hold ring (63) is formed at one end of the sleeve (6). The hold ring (63) is abutted against one end of the code disc (7) for positioning the code disc (7).

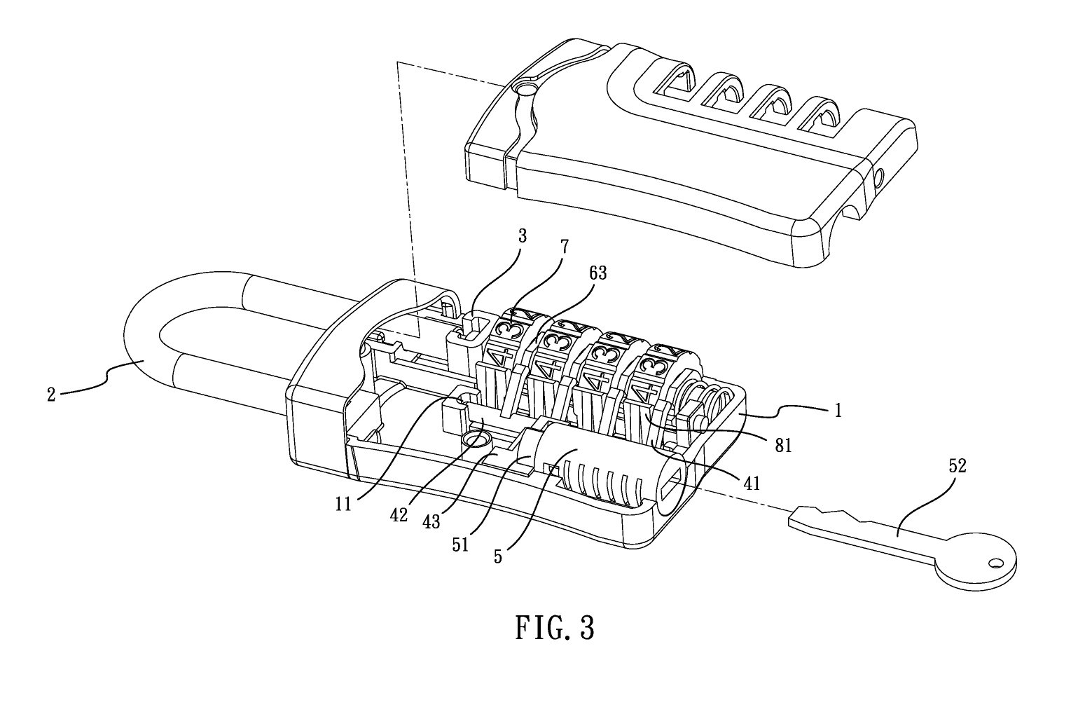

Referring to FIGS. 2-3, when the code disc (7) is located at the groove portion (32) of the stick (3), the sleeve (6) is rotated relative to the groove portion (32) by the rotation of the code disc (7). When the periphery of the first hole (61) is matching to the shape of the block portion (31) via the rotation of the sleeve (6), the block portion (31) is inserted into the first hole (61) so that the stick (3) can move axially relative to the sleeve (6). The code disc (7) is partially exposed out of the body (1) and positioned in the body (1). Thus, the code disc (7) cannot move axially, but the stick (3) can move axially to push the shackle (2) out of the body (1).

Referring to FIGS. 1-3, the pivot set (4) has a plurality of claspers (41) at one side. Another side of the pivot set (4) is abutted against the core (5). The sleeve (6) has a second groove (64) corresponding to the claspers (41). The pivot set (4) has a pivot unit (42). A first groove (11) is defined on the inside wall of the body (1) for receiving the pivot unit (42). The pivot unit (42) has the claspers (41) at one side. The pivot unit (42) has a block pad (43) at another side for abutting against the core (5). An elastomer (44) is mounted on the bottom of the block pad (43). One end of the elastomer (44) is abutted against the block pad (43). Another end of the elastomer (44) is abutted against the inside wall of the body (1). A block rib (51) corresponding to the block pad (43) is formed at one end of the core (5). A positioning base (8) is mounted in the body (1). The positioning base (8) has a plurality of block slices (81). The block slices (81) are respectively adjacent to the code discs (7). The claspers (41) and the block slices (81) are interlaced with each other so that each clasper (41) is positioned between two block slices (81).

The position of the second groove (64) is predefined according to the correct combination digits when the sleeve (6) is produced. Thus, when the periphery of the first hole (61) matches to the shape of the block portion (31), the combination digits of the code discs (7) exposed out of the body (1) are the correct combination digits and unlocks the combination lock.

When users rotate the core (5) with a calibration key (52), the pivot set (4) is pushed by the block rib (51) of the core (5) so as to pivot the pivot unit (42), thereafter, the claspers (41) press on the periphery of the sleeve (6). Under this arrangement, the users rotate the code discs (7) until the second groove (64) engages with the claspers (41) firmly. At this time, the combination digits of the code discs (7) exposed out of the body (1) are the correct combination digits and the periphery of the first hole (61) is matching to the shape of the block portion (31), so that the block portion (31) is inserted into the first hole (61). Thus, the stick (3) is moving relatively to the code discs (7) so that the users pull the shackle (2) out of the body (1) for separating the second end (22) from the body (1) and unlocking. When the users pull out the calibration key (52) from the core (5), the claspers (41) disengage with the second groove (64) of the sleeve (6) instantly. The pivot set (4) is provided with the elastomer (44) so as to recover position. Thereafter, the users push the shackle (2) until the second end (22) is inserted into the body (1) completely and the users rotate the code discs (7) randomly for locking the combination lock. Therefore, if the users forget the correct combination digits, the users can retrace the correct combination digits via the calibration key (52) inserted into the core (5).

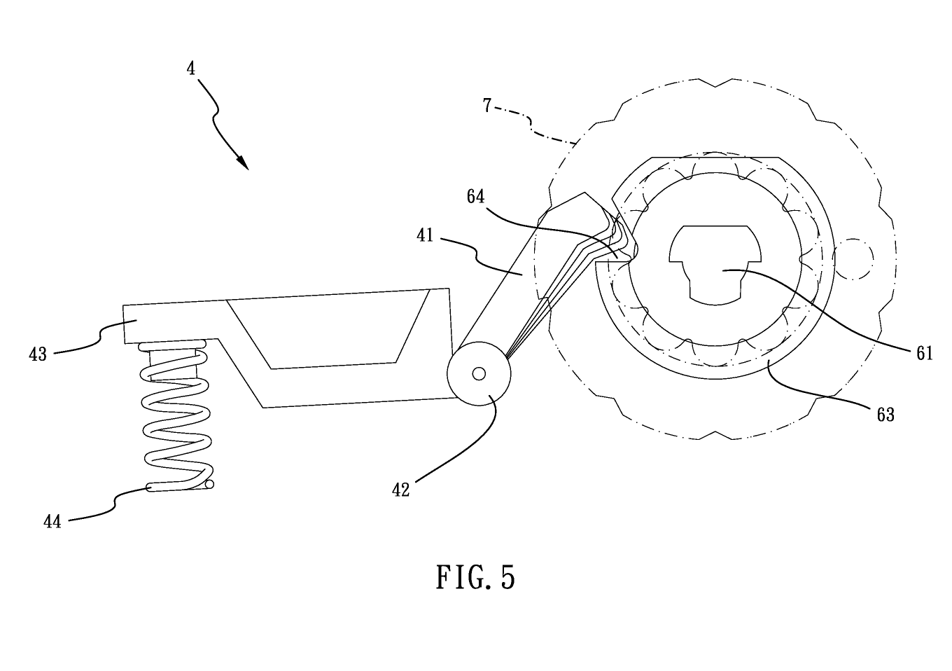

Referring to FIG. 5, when the combination lock is unlocked and the core (5) is not rotated via the key, the distance from the upper clasper (41) to the corresponding upper second groove (64) is shorter than the other distance from the lower clasper (41) to the corresponding lower second groove (64).

Although the invention has been explained in relation to its preferred embodiment, it is to be understood that many other possible modifications and variations can be made without departing from the spirit and scope of the invention as hereinafter claimed.

What is claimed is:

1. A combination lock with retracing combination comprising:
a body, a shackle, a stick, a pivot set, a core, a plurality of sleeves and a plurality of code discs, the stick, the pivot set and the sleeves mounted in the body, the sleeves encircled by the code discs, the code discs partially exposed out of the body, a first hole opened through the sleeve and the sleeve encircling the stick via the first hole, a plurality of block portions and a plurality of groove portions formed on the stick, the block portions and the groove portions interlaced with each other, the cross-section of the groove portion smaller than the cross-section of the block portion, the periphery of the block portion formed as polygon and the shape of the first hole corresponding to the periphery of the block portion, a first end of the shackle connected to one end of the stick and a second end of the shackle inserted into the body, the pivot set having a plurality of claspers at one side and another side of the pivot set abutted against the core, the sleeve having a second groove corresponding to the clasper;
when a user rotates the core with a calibration key, the pivot set is pushed by the block rib of the core so as to pivot the pivot unit, thereafter, the claspers press on the periphery of the sleeve; under this arrangement, the user rotates the code discs until the second groove engages with the clasper firmly, at this time, the combination digits of the code discs exposed out of the body is the correct combination digits and the periphery of the first hole is matching the shape of the block portion, so that the block portion is inserted into the first hole; consequently the stick is moving relative to the code discs so that the user pulls the shackle out of the body for separating the second end from the body and unlocking; thereby if the user forget the correct combination digits, the user can retrace the correct combination digit via the calibration key inserted into the core.

2. The combination lock with retracing combination as claimed in claim 1, wherein a second hole is opened through the center of the ring; at least one third groove is defined around the second hole of the ring; at least one protrusion is formed around the sleeve; the amount of the protrusion is corresponding to the amount of the third groove; the protrusion is connected to the third groove.

3. The combination lock with retracing combination as claimed in claim 1, wherein the pivot set has a pivot unit; a first groove is defined on the inside wall of the body for receiving the pivot unit; the pivot unit has the claspers at one side and has a block pad at another side for abutting against the core; an elastomer is mounted on the bottom of the block pad; one end of the elastomer is abutted against the block pad and another end of the elastomer is abutted against the inside wall of the body.

4. The combination lock with retracing combination as claimed in claim 2, wherein the pivot set has the pivot unit; the first groove is defined on the inside wall of the body for receiving the pivot unit; the pivot unit has the claspers at one side and has the block pad at another side for contacting against the core; the elastomer is mounted on the bottom of the block pad; one end of the elastomer is abutted against the block pad and another end of the elastomer is abutted against the inside wall of the body.

5. The combination lock with retracing combination as claimed in claim 1, wherein a positioning base is mounted in the body and has a plurality of block slices; the block slices are respectively adjacent to the code discs; the claspers and the block slices are interlaced with each other.

6. The combination lock with retracing combination as claimed in claim 1, wherein a hold ring is formed at one end of the sleeve for abutting against one side of the code discs.

7. The combination lock with retracing combination as claimed in claim 1, wherein when the combination lock is unlocked and the core is not rotated via the calibration key, the distance from the upper clasper to the corresponding upper second groove is shorter than the other distance from the lower clasper to the corresponding lower second groove.

8. The combination lock with retracing combination as claimed in claim 3, wherein a block rib corresponding to the block pad is formed at one end of the core.
